(19) United States
(12) Patent Application Publication
(10) Pub. No.: US 2009/0262976 A1
(43) Pub. Date: Oct. 22, 2009

(54) POSITION-DETERMINING SYSTEM AND METHOD

(75) Inventors: GUO-HONG HUANG, Tu-Cheng (TW); CHIA-HUA CHANG, Tu-Cheng (TW); CHUI-HSIN CHIOU, Tu-Cheng (TW); CHAU-LIN CHANG, Tu-Cheng (TW); TSANN-HUEI CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City, (TW)

(21) Appl. No.: 12/203,090

(22) Filed: Sep. 2, 2008

(30) Foreign Application Priority Data
Apr. 17, 2008 (CN) 200810301171.2

(51) Int. Cl. G06K 9/64

(52) U.S. Cl. 382/103

(57) ABSTRACT

A position-determining system for determining position and orientation of an object on a work surface parallel to an X-Y plane of a Cartesian coordinate system includes an image-capturing device, a processor and a recognition assistant. The image-capturing device is directed towards the work surface for capturing images of the object and sending the images to the processor. The processor processes the images captured by the image-capturing device. The recognition assistant is attached on the object. The recognition assistant includes a first recognition assistant part and a second recognition assistant part configured to be readily recognizable in an image examined by the processor. Then the processor determines position and orientation of the object via a template matching algorithm.

### BACKGROUND

1. Field of the Invention

The present invention relates to a position-determining system and method, and particularly to a position-determining system and method for determining position and orientation of an work piece situated on a work surface.

2. Description of Related Art

Generally speaking, a position-determining apparatus for determining position of an work piece on a flat surface such as work table includes an image-capturing device pointing at the table, and a processor for processing images of the work piece on the table. The image-capturing device captures an image of the work piece to be sent to the processor. The position-determining system uses a template matching algorithm to recognize the work piece and calculate the position of the work piece. In other words, the position-determining system uses a template image of the work piece, and compares an image of the work piece on the plane with the template image to determine a position of the work piece. While template matching used in this way may be able to determine the position of the work piece, it can easily fail to detect a change in orientation of the work piece. For example, should the work piece rotate to some degree clockwise or counterclockwise, the template matching function will not report this, and may have trouble even giving the work piece's position. To overcome the above problem the system needs to further use an image recognition algorithm, which is a complex time consuming step.

### BRIEF DESCRIPTION OF THE DRAWINGS

FIG. 1 is a schematic view of a position-determining system in accordance with an embodiment of the present invention together with an work piece positioned on a work surface parallel to an X-Y plane;

FIG. 2 is an exploded, isometric view of the recognition assistant of FIG. 1.

FIG. 3 is an assembled view of FIG. 2;

FIG. 4 shows templates of the position-determining system of FIG. 1;

FIG. 5 shows a first image captured by the image-capturing device of FIG. 1.

FIG. 6 shows a second image captured by the image-capturing device of FIG. 1.

### DETAILED DESCRIPTION

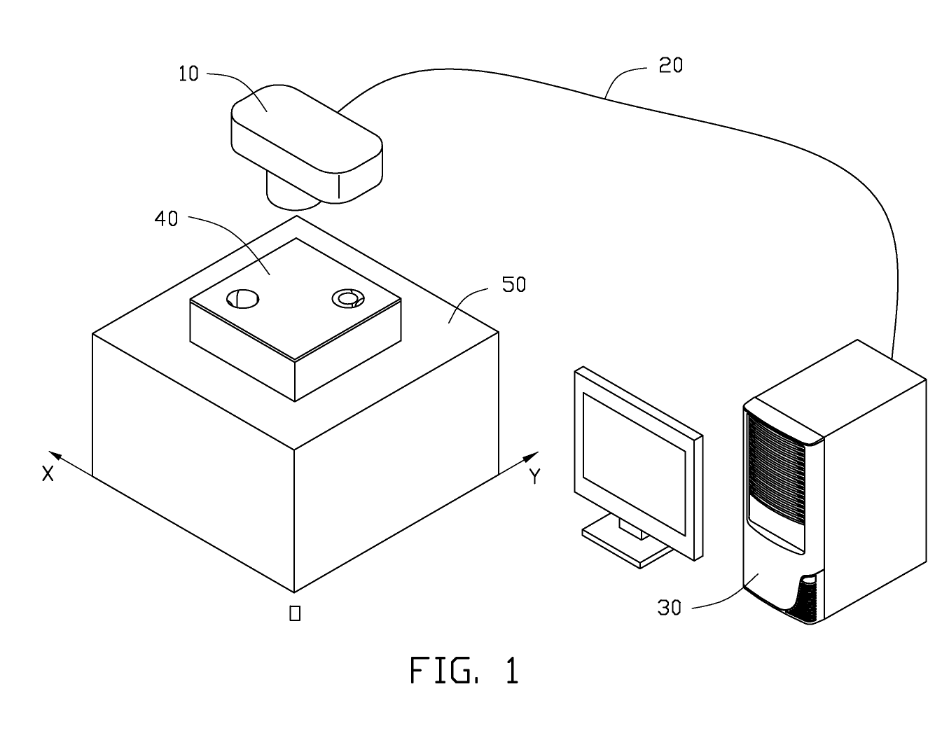

Referring to FIG. 1, a position-determining system in accordance with an embodiment of the present invention is provided for determining position and orientation of an work piece 50 positioned on a work surface parallel to an X-Y plane of a Cartesian coordinate system. The position-determining system includes an image-capturing device 10, a transmission cable 20, a processor 30, and a recognition assistant 40. In a work setting it may be required to know if a work piece 50 has shifted in position and/or orientation during a work process. In the system an initial image is captured of the work piece 50 and its position and orientation established relative to the work surface. Then at determined intervals additional images may be captured and position and orientation of the work piece 50 established again to determine if any shifting has taken place and how much.

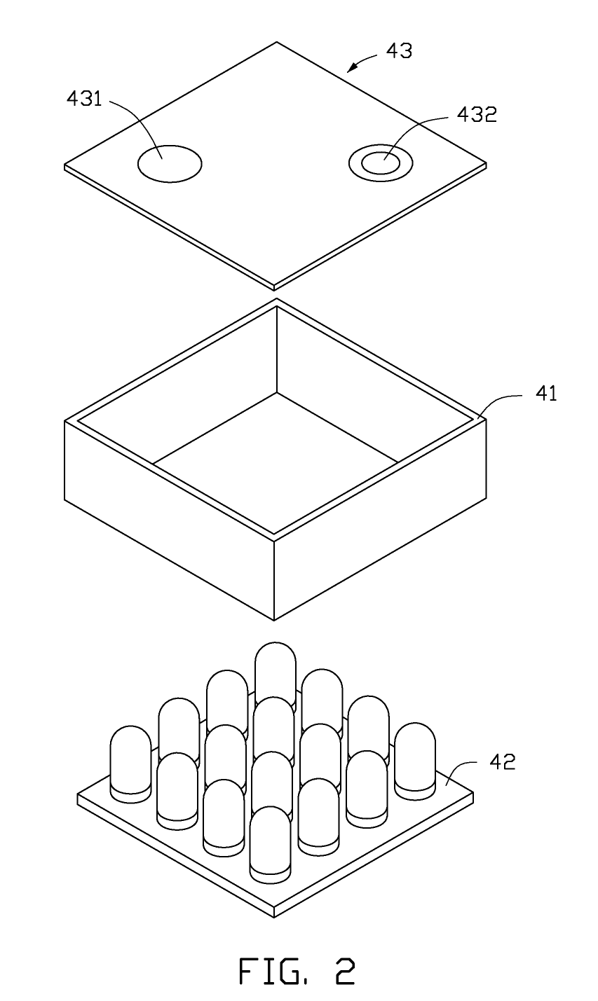

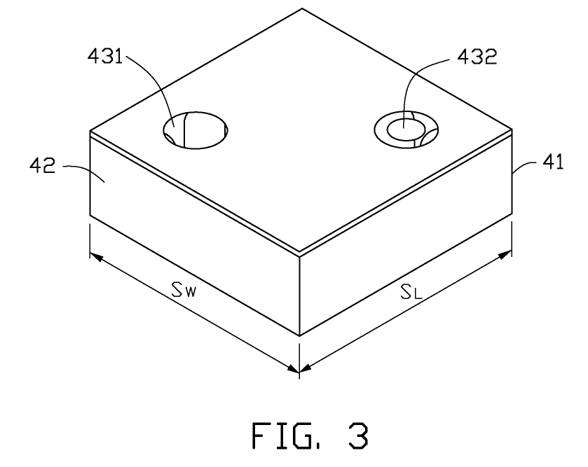

Referring to FIG. 2 and FIG. 3, the recognition assistant 40 is box-shaped. The recognition assistant 40 includes a light source 42, a top panel 43, and a receiving member 41 formed by four sidewalls. The top panel 43 defines a first transparent window 431 and a second transparent window 432 therein. The first transparent window 431 is circle-shaped, and the second transparent window 432 is ring-shaped. The light source 42 is received in the receiving member 41. The top panel 43 is attached to the receiving member 41 to cover the light source 42. S_{L} and S_{W} respectively represent millimeters of the length and width of the recognition assistant 40.

The image-capturing device 10 can be a digital camera. The processor 30 can be a computer. The light source 42 can be an infrared light source configured for avoiding the influence of the environmental light, to enhance the precision of the position-determining system.

Referring to FIG. 1 and FIG. 3, the top panel 43 of the recognition assistant 40 faces upward, and the recognition assistant 40 is attached to the top of the work piece 50. The image-capturing device 10 is directed towards the X-Y plane.

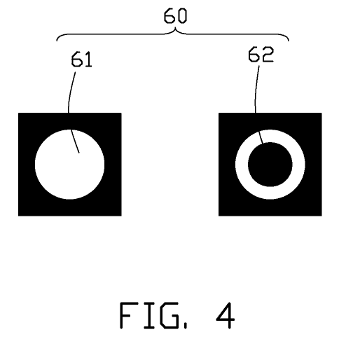

Referring to FIG. 4, in a template 60, a circle 61 and a ring 62 represent the first transparent window 431 and the second transparent window 432 of the recognition assistant 40 respectively.

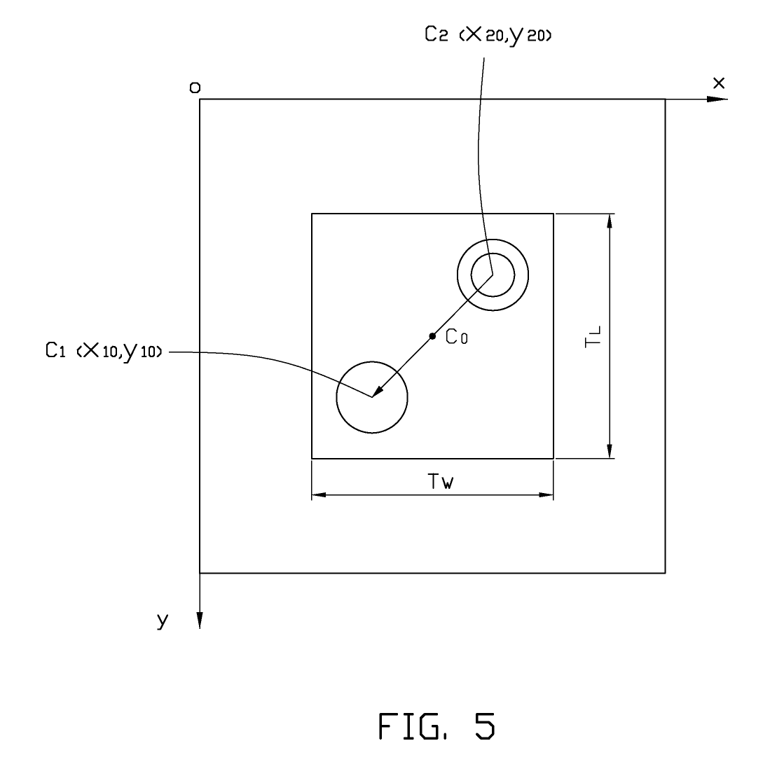

Referring to FIGS. 5 and 7, the image-capturing device 10 captures a first image (see FIG. 5) of the recognition assistant 40 affixed to the work piece 50 which is situated on a work surface and transmits the first image to the processor 30. The processor establishes an image coordinate system xoy (x-axis, origin and y-axis) in the first image and an work piece coordinate system XOY corresponding to the image coordinate system xoy. The image coordinate system xoy and the work piece coordinate system XOY are Cartesian coordinate systems. The unit of the image coordinate system xoy is pixel, and the unit of the work piece coordinate system XOY is millimeter. T_{L} and T_{W} respectively represent the pixels of the length and width of the recognition assistant 40 in the image coordinate system xoy. The processor 30 runs a template matching algorithm, and uses the circle 61 and the ring 62 of the templates 60 to search in the first image to locate the first transparent window 431 and the second transparent window 432. The obtained coordinate of a center C₁ of the first transparent window 431 and the coordinate of a center C₂ of the second transparent window 432 are respectively represented by (x₁₀, y₁₀) and (x₂₀, y₂₀).

In the image coordinate system xoy, the coordinate of a midpoint C₀ of the line connecting the center C₁ of the first transparent window 431 and the center C₂ of the second transparent window 432 is:

$$( \frac{{x}_{10} + {x}_{20}}{2} , \frac{{y}_{10} + {y}_{20}}{2} ) \qquad ( 1 )$$

The expression (1) represents the first position of the work piece 50 in the image coordinate system xoy. The sizes in the images captured by the image-capturing device 10 are in fixed scale, so that the first position of the work piece 50 in the work piece 50 coordinate system XOY is:

$$( ( \frac{{x}_{10} + {x}_{20}}{2} ) \frac{{S}_{L}}{{T}_{L}} , ( \frac{{y}_{10} + {y}_{20}}{2} ) \frac{{S}_{L}}{{T}_{L}} ) \\ or \\ ( ( \frac{{x}_{10} + {x}_{20}}{2} ) \frac{{S}_{w}}{{T}_{w}} , ( \frac{{y}_{10} + {y}_{20}}{2} ) \frac{{S}_{w}}{{T}_{w}} ) \qquad ( 2 )$$

A vector from the center C₂ of the second transparent window 432 to the center C₁ of the first transparent window 431 is represented by:

\vec{C₂C₁}=((x₁₀−x₂₀),(y₁₀−y₂₀)) (3)

The expression (3) represents the first orientation of the work piece 50.

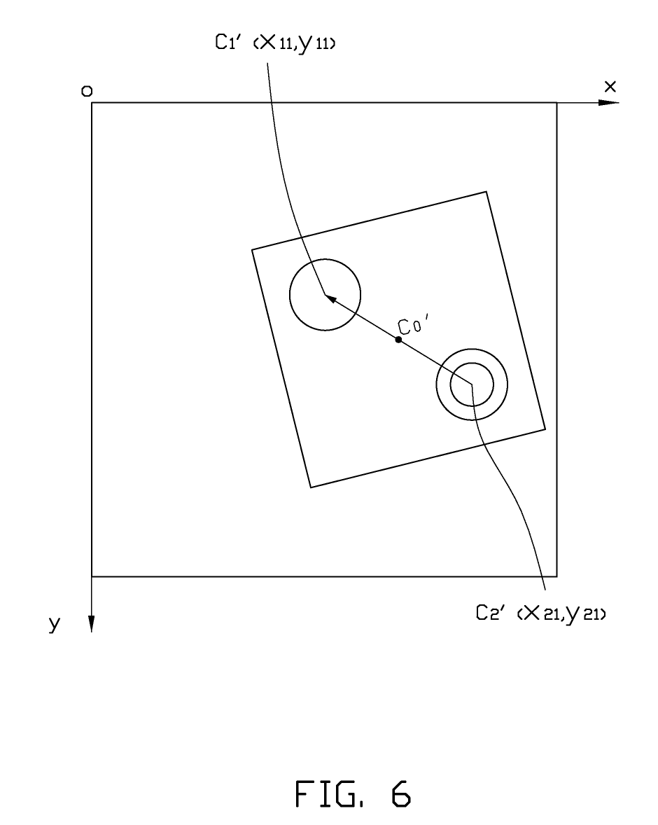

Referring also to FIG. 6, the work piece 50 and the recognition assistant 40 have shifted in position and orientation. The image-capturing device 10 captures a second image (see FIG. 6) and transmits the second image to the processor 30. The processor 30 establish the image coordinate system xoy in the second image at the same place of as the first image. The processor 30 runs the template matching algorithm to recognize the second image. Although the work piece 50 rotates, the images of the transparent windows are sill recognizable because of their shapes. The second position of the work piece 50 in the work piece coordinate system XOY is:

$$( ( \frac{{x}_{11} + {x}_{21}}{2} ) \frac{{S}_{L}}{{T}_{L}} , ( \frac{{y}_{11} + {y}_{21}}{2} ) \frac{{S}_{L}}{{T}_{L}} )$$

$$or \\ ( ( \frac{{x}_{11} + {x}_{21}}{2} ) \frac{{S}_{w}}{{T}_{w}} , ( \frac{{y}_{11} + {y}_{21}}{2} ) \frac{{S}_{w}}{{T}_{w}} )$$

The second orientation of the work piece 50 is:

\vec{C₂′C₁′}=((x₁₁−x₂₁),(y₁₁−y₂₁))

Then, we can tell how much the work piece has shifted in position and orientation based on all of the calculation above.

The foregoing exemplary embodiment of the invention directly uses template matching algorithm as image recognition algorithm to determine position and orientation of the work piece 50.

In other embodiments, the first transparent window 431 and the second transparent window 432 can be respectively replaced by two circle-shaped transparent windows with different sizes or two transparent windows respectively formed by different number of concentric rings. The templates need be adjusted accordingly, the invention will still work.

In the foregoing exemplary embodiments of the invention, the recognition assistant 40 can be replaced by a picture or even a high contrast picture. The picture includes a first colored image similar to the first transparent window 431 and a second colored image similar to the second transparent window 431. The background color of the picture and the colors of the first and the second shapes are in contrast.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A position-determining system, the system comprising:
a work piece positioned on a flat work surface;
an image-capturing device directed towards the work surface;
a processor capable of processing images captured by the image-capturing device; and
a recognition assistant attached on the work piece;
wherein the recognition assistant comprises a first recognition assistant part and a second recognition assistant part, the first and second recognition assistant parts are configured to be readily recognizable in an image processed by the processor running a template matching algorithm.

2. The position-determining system as claimed in claim 1, wherein the recognition assistant is a picture, and the first and the second recognition parts are two different colored images.

3. The position-determining system as claimed in claim 2, wherein the background color of the picture and the colors of the first and the second recognition parts are in high contrast.

4. The position-determining system as claimed in claim 1, wherein the recognition assistant further comprises:
a light source covered by the first and the second recognition assistant parts;
wherein the first and the second recognition assistant part are two different transparent windows.

5. The position-determining system as claimed in claim 1, wherein the first recognition assistant part is circle-shaped, and the second recognition assistant part is ring-shaped.

6. The position-determining system as claimed in claim 1, wherein the first and the second recognition assistant parts are different sized circle-shapes.

7. The position-determining system as claimed in claim 1, wherein the first and the second recognition assistant parts are different sized ring-shapes.

8. The position-determining system as claimed in claim 1, wherein the first and the second recognition assistant parts comprise concentric rings; wherein the first recognition assistant part comprises of a different number of concentric rings than the second recognition assistant part.

9. A method for determining position and orientation of an work piece positioned on a flat work surface, comprising:
providing:
an image-capturing device directed towards the work surface;
a processor; and
a recognition assistant attached on the work piece;
wherein the recognition assistant comprises a first recognition assistant part and a second recognition assistant part, the recognition assistant parts are configured to be readily recognizable in an image processed by the processor running a template matching algorithm;
capturing an image of the recognition assistant by the image capturing device;
establishing an image coordinate system in the image and a corresponding work piece coordinate system;
taking a subsequent image of the recognition assistant;
determining coordinates of the first and the second recognition assistant parts in the image coordinate system as defined by the subsequent image; and
calculating a position of the work piece in the work piece coordinate system.

10. The method as claimed in claim 9, wherein the image coordinate system and the work piece coordinate are Cartesian coordinate systems.

11. The method as claimed in claim 9, wherein the position of the work piece in the work piece coordinate system is represented by the coordinate of a midpoint of the line connecting the centers of the first and the second recognition assistant parts.

12. The method as claimed in claim 9, wherein calculating further comprises establishing an orientation of the work piece; the orientation of the work piece is represented by a vector from the center of the second recognition assistant part to the center of the first recognition assistant part.
